(19) United States
(12) Patent Application Publication
(10) Pub. No.: US 2015/0215413 A1
(43) Pub. Date: Jul. 30, 2015

(54) Modifying Presence Information of a Communication Device

(71) Applicant: QUALCOMM Incorporated, San Diego, CA (US)

(72) Inventors: Mark Aaron Lindner, Verona, WI (US); Lalitha BS Suryanarayana, San Diego, CA (US)

(73) Assignee: QUALCOMM Incorporated, San Diego, CA (US)

(21) Appl. No.: 14/166,948

(22) Filed: Jan. 29, 2014

(51) Int. Cl. H04L 29/08; H04L 12/26

(52) U.S. Cl. CPC H04L 67/24; H04L 43/08

(57) ABSTRACT

Embodiment methods, communication systems and servers determine presence information of a computing device by transmitting a pre-connect probe to the computing device, receiving end-to-end communication stream quality metrics to the computing device based on the pre-connect probe, and determining whether the end-to-end stream quality metrics to the computing device exceed a threshold for each type of communication available with the computing device. The presence information of the computing device may be modified or maintained to available when the end-to-end stream quality metrics exceed the threshold, and to unavailable when the end-to-end stream quality does not exceed the threshold. The pre-connect probe may be sent in response to receiving a request for presence information for a target computing device from a requesting computing device, in which case the pre-connect probe may test the end-to-end communication path between the requesting computing device and the target computing device.

### BACKGROUND

Computing devices, such as mobile phones, smart phones, tablets, and laptop computers, may provide various types of user notifications, including audio, visual, and haptic (e.g., vibration) notifications. Computing devices also include various modes combining or restricting some of these notifications. For example, smart phone set in silent mode to vibrate may not ring, or a laptop allowing a pop up reminder may not sound an alarm when sound is muted. Current computing devices may allow users to control notification modes, such as silencing a ringing phone that may be interrupting a meeting or movie.

While it is convenient for users to be able to control the types of notifications they will receive, others who want to call or send a message (e.g., a text message or email) have no information regarding whether their call or message will be received or ignored due to such notification settings. Also, computing devices may be unable to receive incoming calls or messages due to being disconnected from wireless networks, a status that may not be known to those who call or send messages. This inability to know whether a call or message will be received may be frustrated to computing device users. Typically, users must wait for a response from the recipient or try sending redundant messages to expedite their communication attempts. Message recipients may be inconvenienced by receiving multiple messages and the social discomfort of being unable to easily describe their availability to those attempting to contact them.

### SUMMARY

The various embodiments include methods, as well as servers and communication system implementing the methods for updating or maintaining presence information on a target computing device based on communication link metrics determined by sending a pre-connect probe to the target computing device. An embodiment method may include transmitting a pre-connect probe to the target computing device, receiving a stream quality metric of communication link or links to the target computing device based on or as determined by the pre-connect probe, determining whether the stream quality metric of communication link(s) to the target computing device exceeds a threshold, and modifying presence information regarding the target computing device to “available” (or similar) when the stream quality metric exceeds the threshold and to “unavailable” (or similar) when the stream quality metric does not exceed the threshold. The threshold may be a value of the stream quality metric that indicates a communication link to the target computing device is acceptable for a particular type of communication. The stream quality metric of communication links to the target computing device may be compared to multiple thresholds corresponding to a respective types of communication links, such as a first threshold for video communications, a second threshold for voice communications, and a third threshold for text-based communications. In such embodiments, the presence information may be modified to indicate the availability of the target computing device for each of the plurality of communication types.

Embodiment methods may further include receiving a request for the presence information from a requesting computing device and transmitting the pre-connect probe to the target computing device in response to receiving the request for the presence information. In this embodiment, the modified presence information of the target computing device may be sent to the requesting computing device. This embodiment may also include transmitting a pre-connect probe to the requesting computing device, and determining an end-to-end stream quality metric between the requesting computing device and the target computing device based on stream quality metrics received from both pre-connect probes. In such an implementation, the server may determine whether the end-to-end stream quality metric of communication links between the requesting computing device and the target computing device exceeds the threshold, and modify the regarding the target computing device to “available” for the requesting computing device if the end-to-end stream quality metric exceeds the threshold and to “unavailable” for the requesting computing device if the end-to-end stream quality metric does not exceed the threshold.

Embodiment methods may further include transmitting a pre-connect probe to the target computing device by determining whether the stream quality metric of at least a portion of the communication links to the target computing device are available from one or more storage elements before sending the pre-connect probe. In this embodiment a stream quality metric of communication links to the target computing device may be received based on the pre-connect probe by receiving the stream quality metric of at least a portion of the communication links to the target computing device before sending the pre-connect probe when the stream quality metric is determined to be available from one or more storage elements.

### BRIEF DESCRIPTION OF THE DRAWINGS

The accompanying drawings are presented to aid in the description of embodiments of the disclosure and are provided solely for illustration of the embodiments and not limitation thereof.

FIG. 1A is a communication system block diagram illustrating network components of an example telecommunication system suitable for use in the various embodiments.

FIG. 1B is a communication system block diagram illustrating a situation in which a computing device within the communication system of FIG. 1A is experiencing a week connection.

FIG. 2A is a process flow diagram illustrating an embodiment method for a server to modify presence information of various computing devices based on end-to-end stream quality metrics between computing devices.

FIGS. 2B-2D are process flow diagrams illustrating embodiment methods for a server to modify presence information of various computing devices with respect to particular communication forms.

FIG. 3 is a process flow diagram illustrating an embodiment method for a server to modify presence information of various computing devices in response to receiving a request from an originating computing device.

FIG. 4 is a schematic functional block diagram of presence state information determined by an embodiment system communicating with computing devices within a communication system.

FIG. 5 is a component block diagram of an example server suitable for use with the various embodiments.

FIG. 6 is a component block diagram of an example computing device suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the disclosure or the claims. Alternate embodiments may be devised without departing from the scope of the disclosure. Additionally, well-known elements of the disclosure will not be described in detail or will be omitted so as not to obscure the relevant details of the disclosure.

As used herein, the term “computing device” refers to any wired or wireless computing device, such as desktop computers, cellular telephones, smart phones, personal or mobile multi-media players, personal data assistants (PDA's), laptop computers, tablet computers, smart books, palm-top computers, wireless electronic mail receivers, multimedia Internet enabled cellular telephones, wireless gaming controllers, and similar personal electronic devices which include a programmable processor and memory and circuitry for sending and/or receiving voice and data calls, sending and/or receiving messages (e.g., short message service (SMS) messages, e-mails, application notifications, such as Facebook® post notifications and/or game high score change notifications, etc), sending and/or receiving warnings (e.g., low battery warnings, loss of network connectivity warnings, etc), and/or sending and/or receiving reminders (e.g., calendar reminders, task reminders, etc).

As used herein, the term “stream quality metrics” refers to various measurements of connectivity between various computing devices, such as the quality of connection between the computing devices and their network, as well as the connectivity to a computing device through its network. Stream quality metrics may include, but are not limited to, received signal power (“RxLev”), throughput rates, block error rate (“BLER”), bit error probability (“BEP”), audio quality data, voice traffic channel rates, handover statistics, and radio frequency interference.

The communication capabilities of modern computing devices, particularly mobile devices, have becoming increasingly important in modern societies. For example, people increasingly depend on using mobile devices tablet devices to make voice calls (e.g., PSTN call, VOIP call, cellular call, etc), send text based messages (e.g., SMS, e-mail), and conduct video calls (e.g., Microsoft Lync® call, FaceTime™, Skype™, etc.). As a result, the ability to know whether a person is available or can be reached on their computing device is of greater importance of computing device users. To address this, some application, such as Skype™, provide presence information to computing device users, such as whether another user is logged into the communication service. However, the presence information provided by current communication systems is limited, and unable to reflect whether an intended recipient of a communication is able to receive a video transmission or audio call due to network limitations (e.g., bandwidth limits or technology specific throughput limits). Further, such presence information provides no suggestions of other communication formats that could be use instead, such as a text message. Thus, while the availability of a target computing device is important to users, the available presence information does little to assist them.

To address these limitations of current communication systems, the various embodiments provide methods, devices, and systems for using a pre-connect probe to determine whether a target computing device is available for communicating or receiving communications of a particular form (video, voice, text) based on the target device's stream quality metrics and connection availabilities, and updating presence information that may be used by a variety of communication systems.

In overview, the various embodiments include methods that may be implemented by a server (referred to herein as a “presence server”) that may include transmitting a pre-connect probe to a target computing device (also referred to as a second computing device in some claims), receiving a stream quality metric of communication links to the target computing device based on the pre-connect probe, determining whether the stream quality metric of communication links to the target computing device exceeds a threshold, and modifying presence information regarding the target computing device to “available” (or similar) when the stream quality metric exceeds the threshold and to “unavailable” (or similar) when the stream quality metric does not exceed the threshold. The threshold may be a value of the stream quality metric that indicates a communication link to the target computing device is acceptable for a particular type of communication. Also, the stream quality metric of communication links to the target computing device may be compared to multiple thresholds corresponding to respective types of communication links, such as a first threshold for video communications, a second threshold for voice communications, and a third threshold for text-based communications. In other words, determining whether the stream quality metric of communication links to the target computing device exceeds a threshold may involve determining whether the stream quality metric of communication links to the target computing device exceeds each of a plurality of thresholds corresponding to a plurality of communication types. In such embodiments, the presence information may be modified to indicate the availability of the target computing device for each of the plurality of communication types.

Embodiment methods may further include receiving a request for the presence information from a requesting computing device (also referred to as a first computing device in some claims) and transmitting the pre-connect probe to the target computing device in response to receiving the request for the presence information. In this embodiment, the modified presence information of the target computing device may be sent to the requesting computing device. This embodiment may also include transmitting a pre-connect probe to the requesting computing device, and determining an end-to-end stream quality metric between the requesting computing device and the target computing device based on stream quality metrics received from both pre-connect probes. In such an implementation, the server may determine whether the end-to-end stream quality metric of communication links between the requesting computing device and the target computing device exceeds the threshold, and modify the regarding the target computing device to “available” if the end-to-end stream quality metric exceeds the threshold and to “unavailable” if the end-to-end stream quality metric does not exceed the threshold.

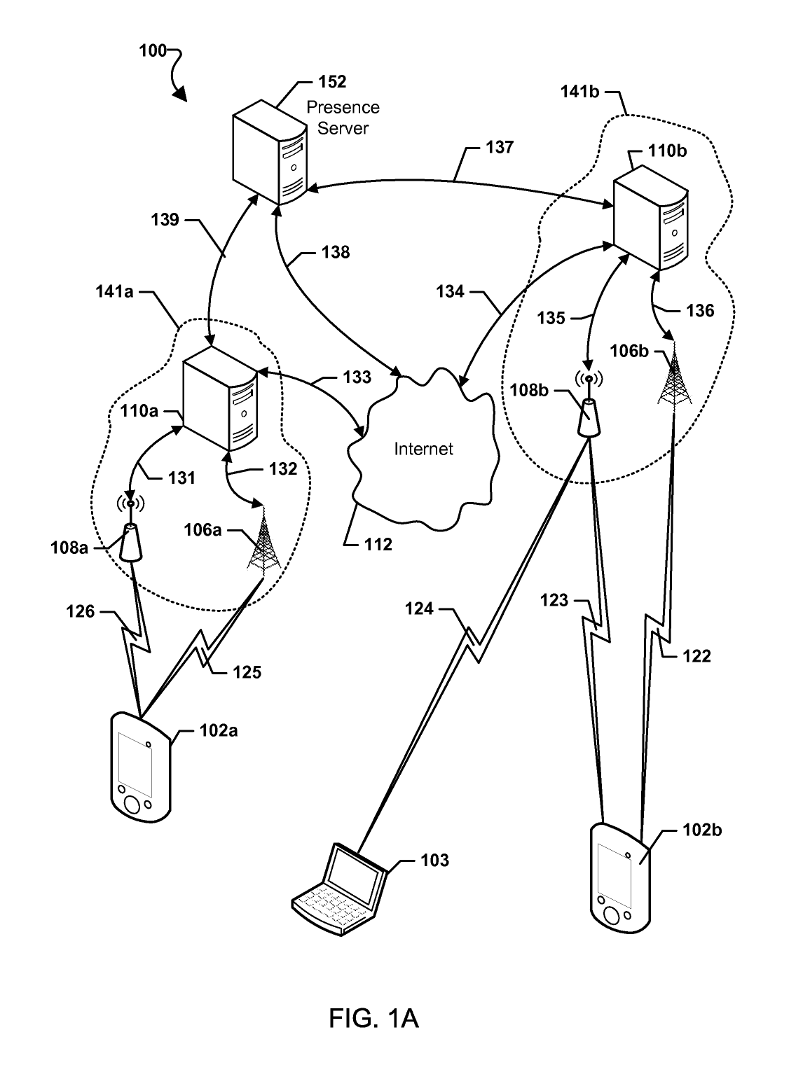

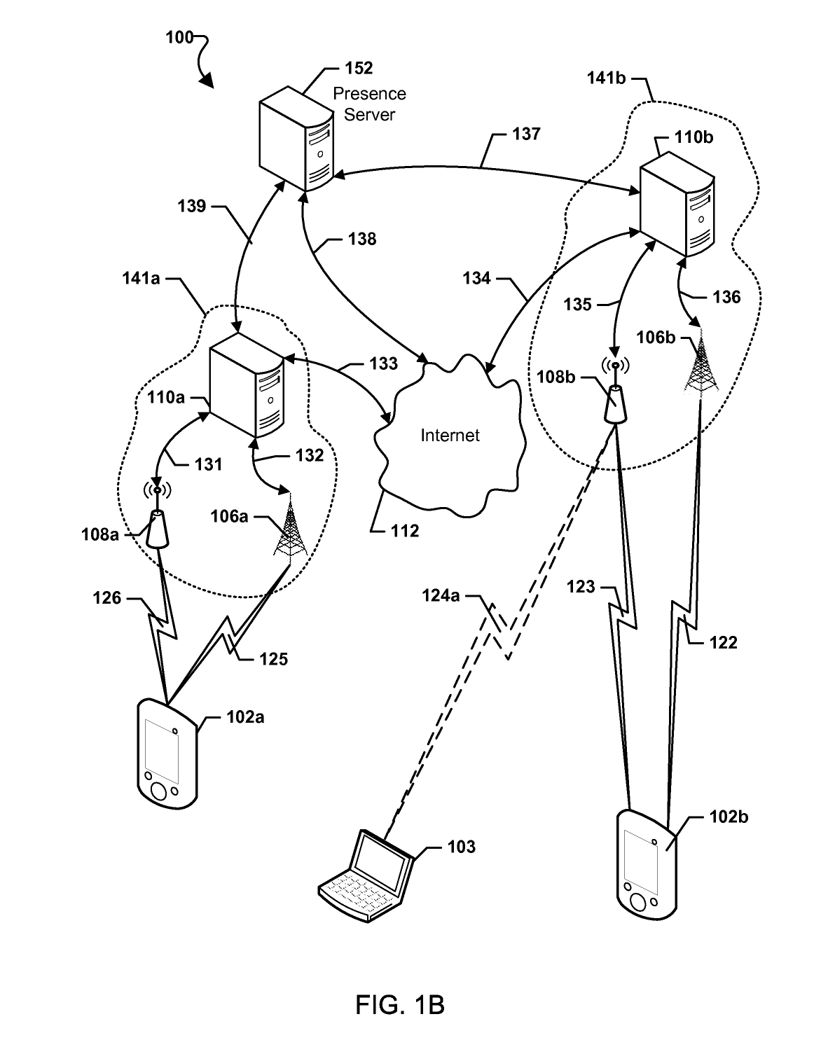

FIG. 1A illustrates a communication system of network 100 suitable for use with the various embodiments including wired and/or wireless data links. The network system 100 may include multiple computing devices such as two mobile devices 102a, 102b (e.g., smart phones) and a laptop computer 103. Although not shown, other wired computing devices may be included in the system, such as a desktop computer.

Each computing device 102a, 103b, 103 may exchange data via wireless data links 126, 125, 124, 123 and 122 with their respective wireless communication networks 141a, 141b. The communication networks 141a, 141b may communicate with a presence server 152 to record the presence state of each computing device 102a, 102b, 103. Communications with the presence server 152 may include a direct communications path from the wireless communication networks 141a, 141b through data links 139, 137, or the networks may communicate with the presence server 152 through the Internet 112 via data links 133 or 134, and 138.

Both wireless communication networks 141a, 141b may include a network server 110a, 110b with a wireless transmitter 108a, 108b and a cellular base station 106a, 106b. Communication between the mobile devices 102a, 102b and the cellular base stations 106a, 106b may be accomplished via two-way wireless communication link 125, 122, such as Wireless Wide Area Network (WWAN) communications (e.g., 4G, 3G, CDMA, TDMA, and other cellular telephone communication technologies). Alternatively, communications between computing devices 102a, 102b, 103 and their respective wireless communication networks 141a, 141b may be accomplished via a two-way communication link 126, 124, 123, such as Wireless Local Area Network (e.g., Wi-Fi, Bluetooth®, Zigbee®, Peanut®, or RF data links).

Regardless of the communication link between a network and the computing device, when an originating computing device intends to communicate with a target computing device, the originating computing device (or a user operating the originating computing device) may want to know whether the target computing device (or the user operating the target computing device) is available for a particular type of communication session (e.g., video, voice, text, or some combination thereof).

In an embodiment, a presence server 152 may send a pre-connect probe between two computing devices that intend to communicate in order to determine the network conditions between the two devices and thus the actual presence of each computing device relative to one another for different communication types. For example, the presence server may transmit a pre-connect probe to the laptop computer 103 and the mobile device 102a to obtain one or more end-to-end stream quality metrics between the two devices. After obtaining the end-to-end stream metrics between the laptop computer 103 and the mobile device 102a, the presence server 152 may determine whether the one or more stream quality metrics are suitable for each type of communication that the devices are capable of exchanging.

FIG. 1B illustrates the same example system 100 of communication networks as shown in FIG. 1A, except that the computing device 103 has a weak wireless data link 124a (illustrated as a dashed wireless data link) with a wireless transmitter 108b of network 141b. In this example, if a mobile device 102a attempts to establish a video communication session with the laptop computer 103, this may prompt the presence server 152 to perform a pre-connect probe collecting one or more end-to-end steam quality metrics between the mobile device 102a and the laptop computer 103. From the pre-connect probe, the presence server may determine based on the one or more measured end-to-end stream metrics that the networks connecting the two devices cannot support a video call, but are suitable for voice calls and text-based messages. The presence server may update the presence information for the laptop computer 103, storing that information in memory or a database that can be accessed by networks and computing devices. The presence server 152 may send a message to the mobile device 102a conveying the presence state of the laptop computer 103, and the mobile device 102a may store the presence information in its memory or a database. So informed, the mobile device 102a may inform the user and suggest that the user initiate a voice-over-IP (VoIP) call or send a text or email message to the laptop computer 103 instead of attempting a video conference.

By having more accurate presence information based on connection quality (i.e., stream quality metrics) for one or more types of communication (e.g., video, voice, and/or text), the originating computing device may use a more appropriate communication method for communicating with the target computing device. Thus, the user of the originating or transmitting computing device may efficiently communicate with the target computing device using a type of communication is more likely to be successful, thereby reducing frustrations stemming from undelivered messages or interruptions in communication sessions that may occur when a communication link between the required devices does not have enough network support (e.g., a weak signal).

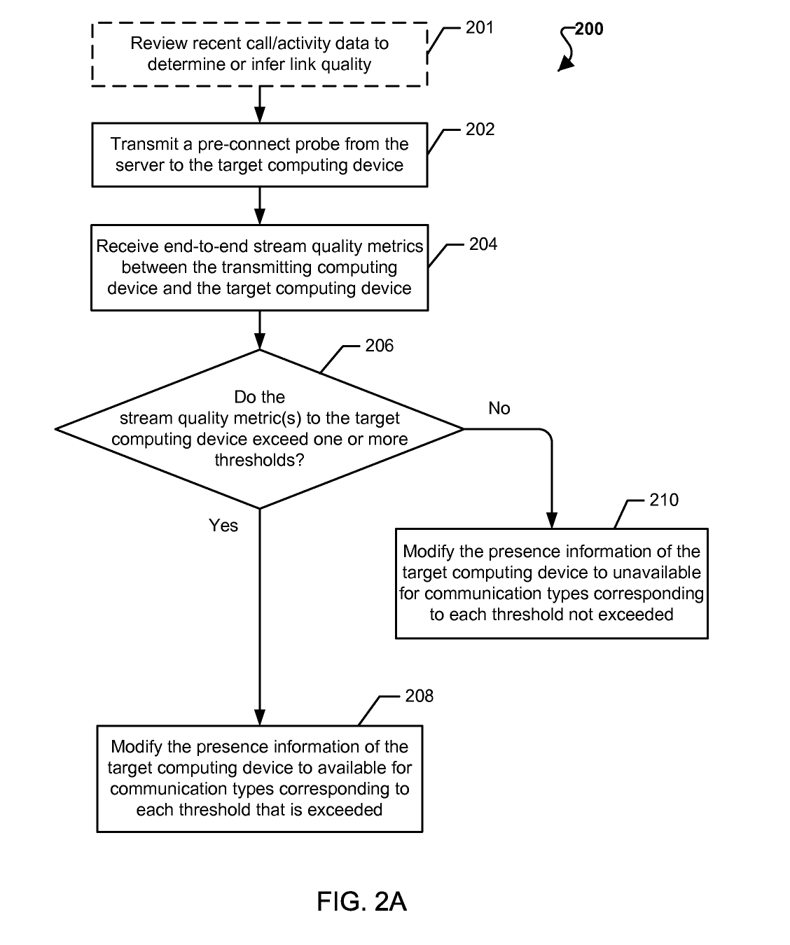

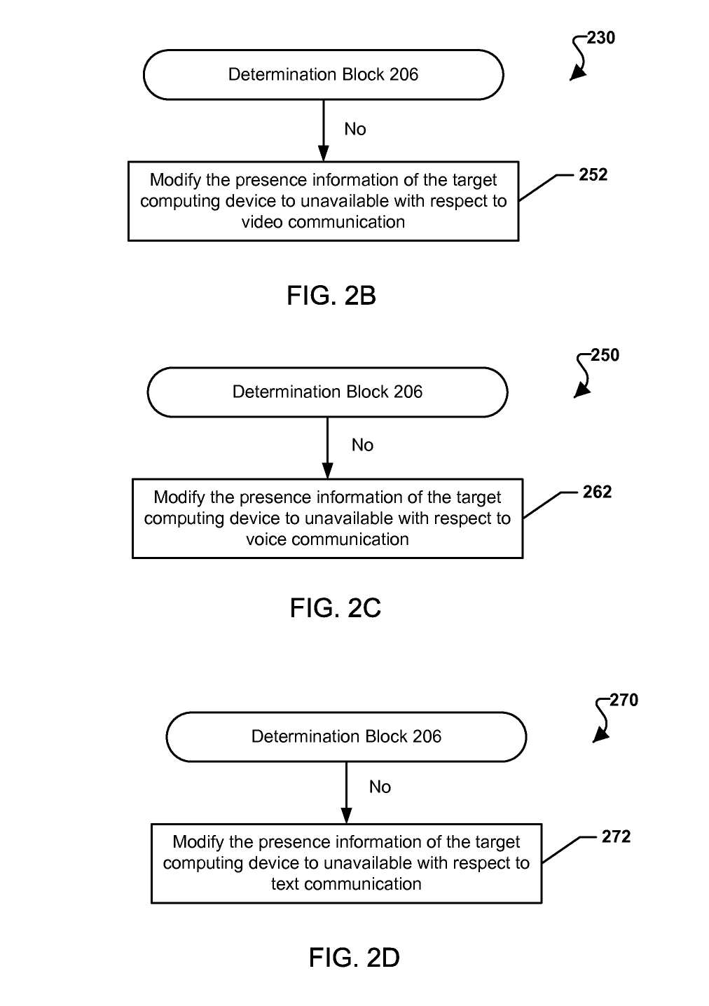

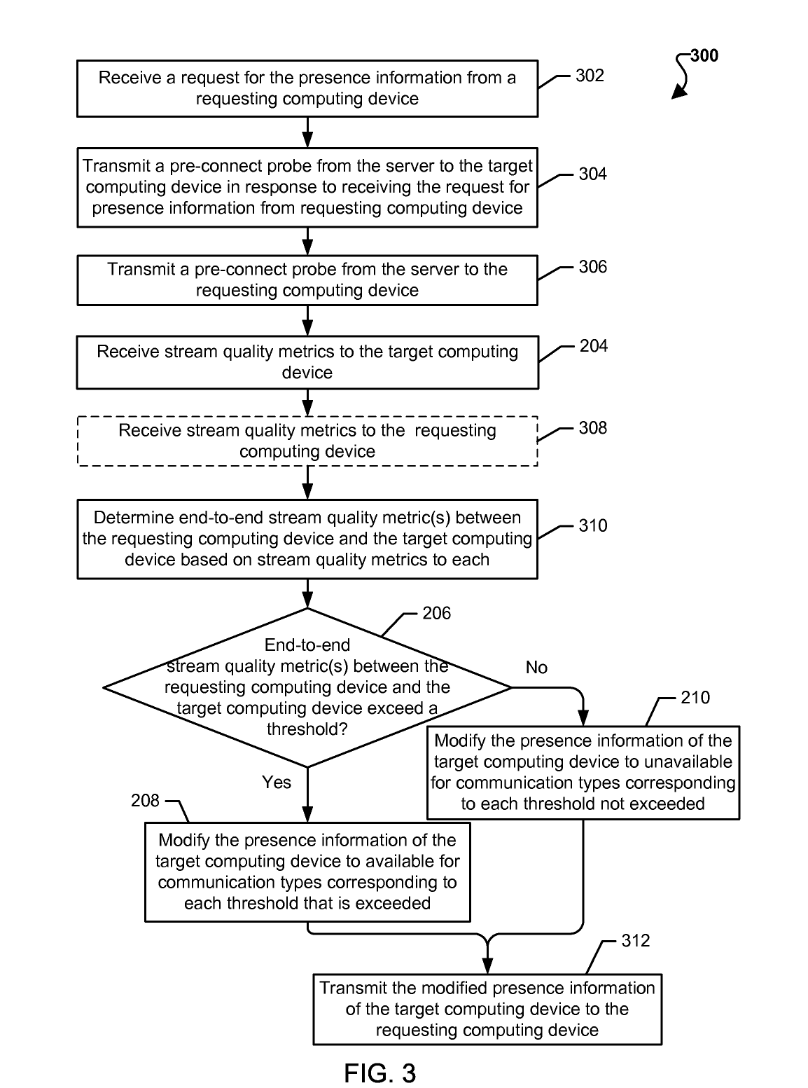

FIG. 2A illustrates an embodiment method for a presence server to modify presence information or the presence information of various computing devices in memory or in a database based on end-to-end stream quality metrics between the computing devices. In an embodiment, the presence server 152 may be an independent application server such as the QChat Application Server (“QAS” in figures). The QChat Application Server may, on its own accord or upon the request of an originating or requesting computing device (as described with respect to FIG. 3), transmit the pre-connect probe as an announce message to one or more computing devices such as mobile devices 102a, 102b, and the laptop computer 103, which may include the requesting device and target computing devices. The embodiment method 200 may be implemented on one or more processors of one or more presence servers. For the sake of conciseness and clarity, method 200 is described as implemented by a presence server, such as the presence server 152 illustrated in FIG. 1A and FIG. 1B.

In optional block 201, a presence server may review recent call data or activity data to establish communication link quality for the link or links to be established. The communication link quality may be determined or inferred by obtaining and analyzing one or more of various elements of stored data associated with current or previous end-to-end communication links or streams. For example, a presence server may obtain and analyze stored data that relates to recent calls or activity, which may be stored in call history logs or other records. Recent calls or activity may include any activity that occurs within a predetermined time period. Any recent end-to-end communication link or stream that occurs within the predetermined time period may be used to calculate the end-to-end link quality for the links to be established. The calls or activity may include voice-over-IP (VoIP) calls, video calls, data session, or other activity, from the same or another service.

The stored data may include a user satisfaction measure for the call. For example, Skype may request a user to evaluate call quality after a Skype call is completed. The stored data may further include packet erasure rate (PER) data. The stored data may further include data associated with a device log of network packets that successfully arrived. In some instances, subjective data, such as a log of user satisfaction measures, may provide only an estimate of communication link quality. The presence server may infer that if a significant number of previous users were satisfied with the call quality on the previously established communication links, then there is a high likelihood that the user for the link to be established will also be satisfied with future quality, at least in the near term. However, when using actual previous call quality data (e.g., PER, packet arrival, etc.) the presence server may assess the actual call quality data as if it were collected in real-time based on a pre-probe signal. A pre-probe embodiment is described in greater detail hereinafter.

Additionally, an end-to-end call requires both a forward or up link and a reverse or down link, which refer generally to the link between the calling party and the calling party's local infrastructure (forward link), and the link between called party and called party's local infrastructure (down link). In embodiments, a presence server may separately track per-link, per-leg call-quality data of each of the forward and down links. Using per-leg per-link data, a presence server may calculate probable call quality for the communication link to be established without the need for a pre-probe. In embodiments, in the short term, the same forward link is generally used between the calling party and the calling party's local infrastructure for all calls while the calling party is within a given calling location. Thus, the call history data from any recent call originating from the calling party may be used to calculate a probable call quality for a new call on the forward link. In other words, in this embodiment, the forward link data need not be collected from a call between two specific end points involved in the future call. Instead, the calling party's (A) call quality data associated with the forward link from a recent call between A and a called party (B) may be used to determine the forward or up link quality for A in a near future call between A another called party (C). A similar method may be used to determine the reverse or down link call quality for one or more of the called parties (B, C). For example, reverse or down link call quality data for B may be retrieved by a presence server as part of a presence data update. In an embodiment, recent link quality data may be stored at a central server. The recent link quality data associated with the presence data of a party may also be distributed in a number of other ways.

Alternatively or in addition to the operations performed in block 201, in block 202, a presence server may transmit a pre-connect probe to a target computing device in order to obtain communication screen quality metrics for communication links to the target computing device. The pre-connect probe may be a type of communication that connects with the target computing device long enough in order for network complements to measure the end-to-end communication link quality, but without establishing a long-duration communication link. While the pre-connect probe may a short-duration probe, which is likely to satisfy most use cases, in some embodiments and applications the pre-connect probe may be a long-duration ‘probe’ that may continuously monitor a link and provide updates throughout its existence. For example, the pre-connect probe may be an opaque stream that is sent through a particular communication link. Also, separate pre-connect probes may be sent through each of the communication links to the target computing device, such as a video pre-connect probe, a push-to-talk pre-connect probe, a voice call pre-connect probe, an SMS pre-connect probe, an email pre-connect probe, etc. For ease of reference, the different types of pre-connect probes that may be sent via each of the communication links to the target computing device are referred to herein simply as a pre-connect probe without further differentiation.

In an embodiment, a pre-connect probe may be one-way only communication in which an originator computing device (e.g., a server) requests data from a target computing device but does not provide any data itself. In an alternative embodiment, or a pre-connect probe may be a two-way communication that also provides what the originator computing device (e.g., a server) believes to be the link quality for its leg. Thus, in this embodiment the pre-connect probe may be an end-to-end connection that has an upstream leg and downstream leg.

In the various embodiments, any and all network options (e.g. QoS) that may be of value or required by the main communication stream may be used or turned on for use as a pre-connect probe.

In further embodiments, a pre-connect probe may be conducted over and involve testing multiple communication routes/bearers. Such probes of multiple communication routes/bearers may be accomplished in parallel (i.e., at approximately the same time or in the same set of operations), sequentially, or sequentially as necessary to find a reliable connection to the target computing device. For example, a pre-connect probe operation may pre-probe communication links via an LTE network, and then pre-probe communication links via an available WiFi network if the pre-connect probe of the LTE reveals that such a connection exhibits poor quality.

In an embodiment, the presence server may transmit the pre-connect probe periodically in block 202, such as hourly, to the computing device or long computing devices registered for the service in order to maintain a current presence database. In another embodiment, the presence server may transmit pre-connect probes in block 202 in response to requests for information from communication networks, service providers, application servers, and other third parties that need to maintain an accurate presence database. In another embodiment, the presence server may determined that it should transmit a pre-connect probe to the mobile computing device in block 202 based upon information obtained about network conditions, such as reports of network service disruptions, weather forecasts, feedback from computing devices, etc.

In an embodiment, the pre-connect probe is transmitted to each end computing device (e.g., computing devices 102a, 102b, and 103). However, due to network failures or weak connections between a particular computing device (e.g., the laptop computer 103 in FIG. 1B) and a network, the pre-connect probe may only reach the connection point just prior to the target computing device (e.g., the BTS/RAN).

In block 204, the presence server may receive stream quality metrics regarding the communication link to the target computing device in response to the pre-connect probe. Such stream quality metrics may be reported by the various network components and nodes that handle the pre-connect probe to the target computing device. In an embodiment, the target computing device and/or a base transceiver station (“BTS”) and/or the radio access network (“RAN”) may send stream quality metrics back to the presence server in response to the pre-connect probe. In an embodiment, the target computing device may include a processor configured with processor-executable instructions to perform operations that include replying to the pre-connect probe from the server by transmitting a message including at least one stream quality metric of the communication link communicating the pre-connect probe to the target computing device (i.e., of the link over which the target computing device received the pre-connect probe). If the pre-connect probe only reaches a connection node just prior to the target computing device (e.g., the BTS/RAN), that node may respond to the pre-connect probe providing stream quality metrics of the target computing device to the presence server 152.

In an embodiment, the response from the one or more target computing devices, intermediate communication nodes, and/or a connection node just prior to the target computing device may be an accept message to the pre-connect probe announce message. The response from any particular computing device and/or a BTS/RAN provides the presence server with metrics to enable it to determine the availability of each computing device in a particular network.

In determination block 206, the presence server may determine whether the end-to-end stream quality metrics between the transmitting computing device and the target computing device exceed one or more thresholds for reliable communications.

If the presence server determines that the end-to-end metrics between the transmitting computing device and the target computing device do not exceed a threshold (i.e., determination block 206=“No”), the presence server may modify the presence information of the target computing device to unavailable for the corresponding type of communication in block 210. For example, if the presence server receives end-to-end stream quality metrics do not satisfy a threshold for video calls, the presence server may modify the presence information for the computing devices to unavailable for communication using video call protocols, such as Microsoft Lync® (“Lync”), Skype™ (“Skype”), FaceTime™ (“FaceTime”), etc.

If the presence server determines that the end-to-end stream quality metrics between the transmitting computing device and the target computing device exceed a threshold (i.e., determination block 206=“Yes”), the presence server may modify the presence information for the target computing device to available in block 208.

In embodiments in which the pre-connect probe is sent to multiple target computing devices, the operations of method 200 may be repeated for each target computing device. Also, the presence information may not be modified in blocks 208 and 210 if the threshold determination in determination block 206 is consistent with the current presence information maintained by the presence server.

The operations in determination block 206 and blocks 208 and 210 may be repeated for each type of communication form that is tracked by the presence server. In other words, the presence server may compare the end-to-end stream quality metrics to a plurality of thresholds corresponding to a plurality of communication types. For example, the presence server may compare the stream quality metrics to a first threshold for video calls, and modify the presence information of the target computer to indicate that it is unavailable for video communication in block 252 as illustrated in FIG. 2B. The presence server may also compare the stream quality metrics to a second threshold for voice calls, and modify the presence information of the target computer to indicate that it is unavailable for voice communication in block 262 as illustrated in FIG. 2C. The presence server may also compare the stream quality metrics to a third threshold for text communications, and modify the presence information of the target computer to indicate that it is unavailable for text communication in block 272 as illustrated in FIG. 2D. Thus, a computing device that has less than optimal stream quality metrics (e.g., bandwidth, signal strength, etc.) may be unavailable for one form of communication (e.g., video), while still available for other forms of communication that require lower bandwidth (e.g., audio and/or text). The presence server may also compare the stream quality metrics to other thresholds associated with other types of communication supported by the target computing device and its associated networks.

FIG. 3 illustrates an embodiment method 300 that may be implemented on a presence server for determining presence information in response to a request for that information. Method 300 includes similar operations as in method 200 described above with reference to FIG. 2A. For sake of clarity and conciseness, only the new or different steps are described below.

In block 302, the presence server may receive a request for presence information for a target computing device from a requesting computing device (e.g., the transmitting or originating computing device). For example, a mobile device may transmit a request to the presence server requesting the presence state for a laptop computer with which a user of the mobile device would like to initiate a communication. As another example, the presence server may receive a request for presence information for a target computing device from a communication network operator or a server providing application presence

In block 304, the presence server may transmit a pre-connect probe from the server to the target computing device in response to receiving the request for the presence information of the target computing device from a requesting computing device. Thus, unlike method 200, the presence server in method 300 may transmit the pre-connect probe in response to receiving a request from a computing device to communicate with a target computing device.

In an embodiment, in addition to transmitting a pre-connect probe to the target computing device, the presence server may also send a pre-connect probe (or similar probe) to the requesting computing device in block 306 in order to obtain steam quality metrics for the requesting computing device portion of the end-to-end communication link between the requesting computing device and the target computing device. For example, in response to the request from the mobile device, the presence server may transmit the pre-connect probe to the laptop computer 103 and back to the mobile device 102a to determine the end-to-end stream quality metrics between the two computing devices.

In block 204, the presence server may receive stream quality metrics to the target computing device as described above with reference to FIG. 2A. Similarly, in block 308, the presence server may receive stream quality metrics to the requesting computing device.

In block 310, the presence server may use the received stream quality metrics to the target computing device and to the requesting computing device in order to determine one or more end-to-end stream quality metrics between the two computing devices. This one or more end-to-end stream quality metrics between the two computing devices may reflect all of the communication quality issues that exist in communication links between the two computing devices.

The operations in determination block 206, and blocks 208 and 210 are similar to the operations in like number blocks of method 200 as described above with reference to FIG. 2A, as well as blocks 252, 262 and 272 as described above with reference to FIGS. 2B-2D.

In block 312, the presence server may transmit the modified presence information (whether modified to available from block 208 or unavailable from block 210) to the requesting computing device. For example, once the presence server receives the stream quality metrics between the two computing devices (e.g., the mobile device 102a and the laptop computer 103), the presence server the availability of each computing device, modifies the availability presence information of the target competing device, if necessary, and transmits that presents information to the requesting computing device. The requesting computing device may then use the received presence information to determine the appropriate communication type to use for communicating with the target computing device.

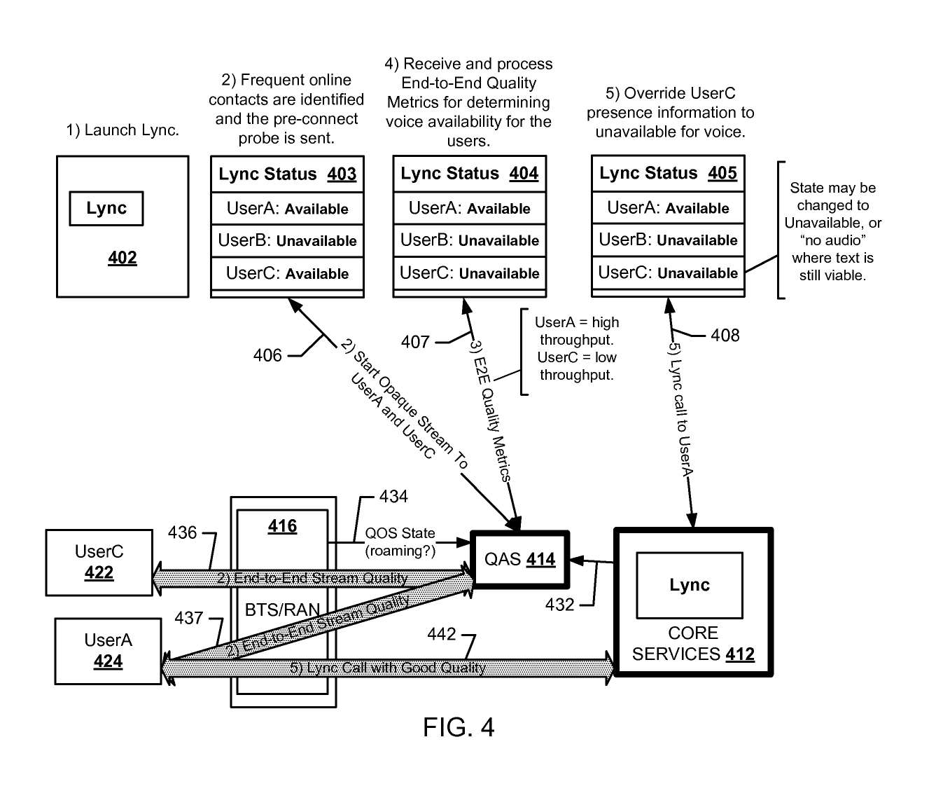

FIG. 4 is functional schematic block diagram illustrated an example communication system and methods for maintaining presence information with a pre-connect probe and one or more end-to-end stream quality metrics.

For simplicity, Lync is the communication application that is described in this example, however, the embodiment methods our not software application specific, and may be implemented with a variety of communication protocols and applications. Generally, Lync is program used with a Microsoft Lync Server or Lync Online that includes instant messaging, Voice Over IP (VOIP), and video conferencing. Lync enables communication between multiple computing devices through text (e.g., instant messaging), VOIP (e.g., voice), and video conferencing (e.g., video).

As illustrated in FIG. 4, a computing device, such as the mobile device (illustrated as UserA in FIG. 4) may launch the Lync application in functional block 402. Once launched, the presence server may identify frequent online contacts of the mobile device and send a pre-connect probe to each of the online contacts to determine the availability of each user in block 403. For example, block 403 illustrates three frequent contacts for mobile device 102a, which are labeled as UserA (e.g., the originating user), UserB, and UserC. UserA, which just launched the Lync application and UserC are illustrated as having an initial availability with respect to audio communications, while UserB is shown as being unavailable with respect to audio communications. These initial availabilities may be based on whether the particular user's device is powered on, connected to any network, or whether the user's device has launched the Lync application.

The presence server may send a pre-connect probe as a short message or an opaque stream to UserA and UserC as shown by communication links 406, 436, and 437, which may be similar to any communication link describe with respect to FIGS. 1A and 1B. The pre-connect probe may be sent through the presence server, or in this case the QCHAT application server 414 (QAS 414 in FIG. 4), to UserC 422 through communication link 436 and to UserA 424 through communication link 437, in which case each user device may respond with connection stream quality metrics. For example, the originator (e.g., UserA) may transmit way call message to the QCHAT application server, and the QCHAT application server may send an announce message to one or more target computing devices (e.g., UserB) and, optionally, to the requesting computing device. The target computing device, and optionally the requesting computing device may reply with an accept message through the communication links 436 and 437, respectfully. Responses from one or more target computing devices may inform the QCHAT application server, which in turn may inform the requesting computing device (e.g., UserA) through data link 437 of where to send the end-to-end link quality data.

In block 404, the QCHAT application server 414 may update the Lync presence information for each user after it processes the end-to-end stream quality metrics for voice availability for the users. The QAS 414 may determine based on the end-to-end stream quality metrics that UserA has availability for high data throughput (e.g., video, voice, and/or text communications), while UserC has availability for low data throughput (e.g., not available for video or voice communications, but available for text communications). As shown, the user statuses of each user in block 404 is the same as block 403, except that the availability for UserC is labeled as unavailable due to poor network connections as a result from the end-to-end stream quality metrics. The poor network connection of UserC (or roaming state) may be communicated from BTS or RAN 416 to the QCHAT application server 414 through a wired or wireless data link 434.

Based on the end-to-end stream quality metrics analysis completed by the QCHAT application server 414, UserA may communicate with the core services of Lync 412 through data link 442 reporting that UserA has availability for a Lync voice call with a good/high quality of service, but UserC does not have availability for a Lync voice call because of its poor network connection. The Lync core services 412 may update the Lync Voice Status for UserC to unavailable as illustrated in block 405. Alternatively, the Lync core services 412 may update the availability of UserC to no audio, if UserC is still able to communicate via text. The Lync core services 412 may communicate the change in status of UserC back to the QCHAT application server 414 so that the QCHAT application server 414 can update the status of the user with respect to other services (e.g., FaceTime, Skype, GoToMeeting, etc.) as needed.

As mentioned above, the various embodiments are not software application specific and may be applied a wide variety of communication protocols, applications and platforms. Thus, the embodiments described above regarding availability may be employed with a number of different communication applications and protocols (e.g., Skype, FaceTime, QChat™, AIM®, Google Chat™, GotoMeeting®, etc.).

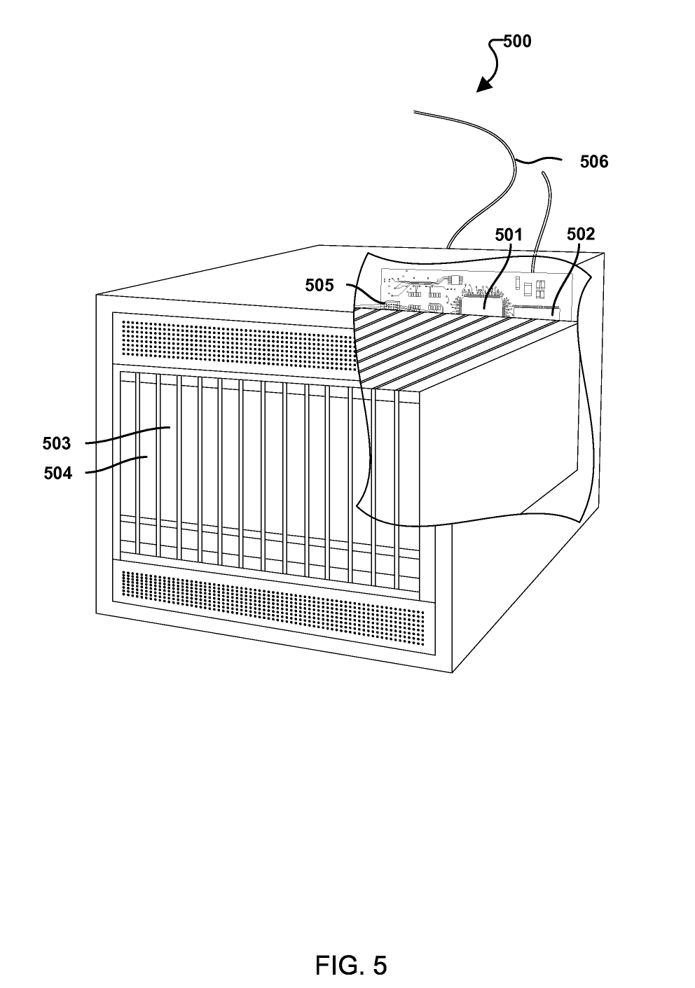

The embodiment methods of the presence server may be implemented on any of a variety of commercially available server devices, such as the server 500 illustrated in FIG. 5. Such a server 500 typically includes a processor 501 coupled to volatile memory 502 and a large capacity nonvolatile memory, such as a disk drive 503. The server 500 may also include a floppy disc drive, compact disc (CD) or digital versatile disc (DVD) disc drive 504 coupled to the processor 501. The server 500 may also include network access ports 505 coupled to the processor 501 for establishing data connections with a network 506, such as a local area network coupled to other broadcast system computers and servers. Such server 500 may also include a database or be connected to a remote database.

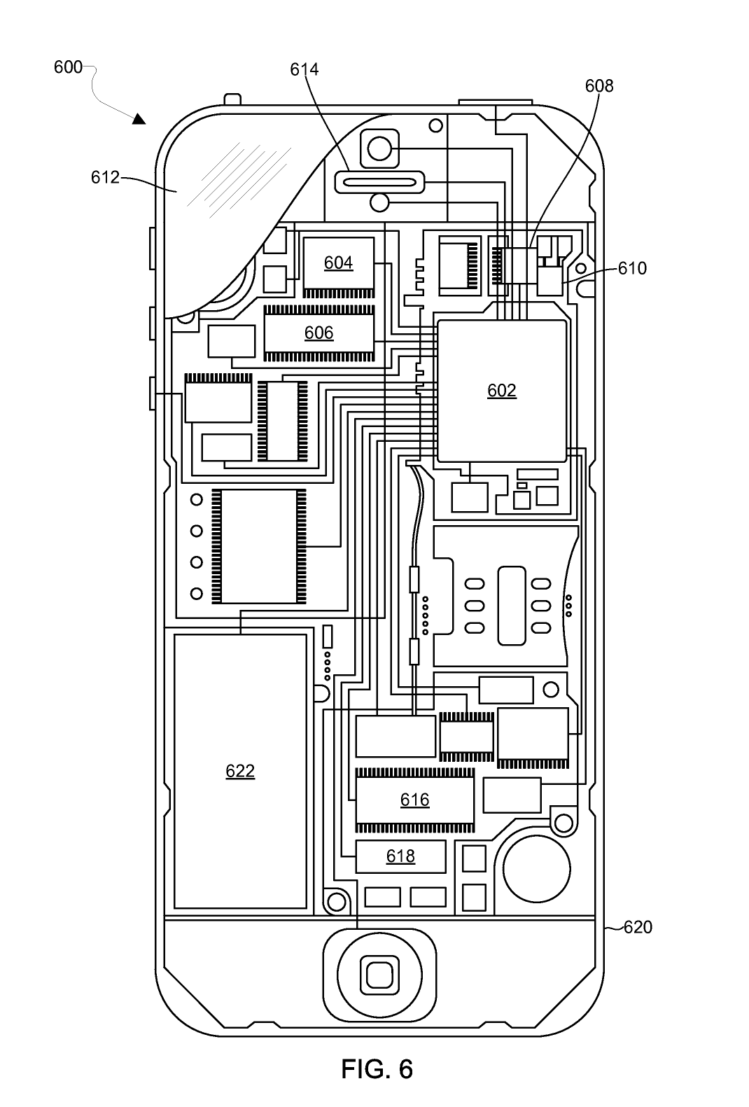

FIG. 6 illustrates an example of a device 600 suitable for use with the various embodiments, such as a target computing device or a transmitting/originating computing device. In various embodiments, the computing device 600 may include a processor 602 coupled to a touchscreen controller 604 and an internal memory 606. The processor 602 may be one or more multicore ICs designated for general or specific processing tasks. The internal memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. The computing device 600 may have one or more radio signal transceivers 608 (e.g., Peanut®, Bluetooth®, Zigbee®, Wi-Fi, RF radio) and antennae 610, for sending and receiving, coupled to each other and/or to the processor 602. The transceivers 608 and antennae 610 may be used with the above-mentioned circuitry to implement the various wireless transmission protocol stacks and interfaces. The computing device 600 may include a cellular network wireless modem chip 616 that enables communication via a cellular network and is coupled to the processor. The computing device 600 may include a peripheral device connection interface 618 coupled to the processor 602. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not shown). The computing device 600 may also include speakers 614 for providing audio outputs. The computing device 600 may also include a housing 620, constructed of a plastic, metal, or a combination of materials, for containing all or some of the components discussed herein. The computing device 600 may include a power source 622 coupled to the processor 602, such as a disposable or rechargeable battery. The rechargeable battery may also be coupled to the peripheral device connection port to receive a charging current from a source external to the computing device 600.

The processors 501, 601 may be any programmable microprocessor, microcomputer or multiple processor chip or chips that can be configured by software instructions (applications) to perform a variety of functions, including the functions of the various embodiments described above. In some computing devices including the server 500 or computing device 600, multiple processors 501, 601 may be provided, such as one processor dedicated to wireless communication functions and one processor dedicated to running other applications. Typically, software applications may be stored in the internal memory 502, 606 before they are accessed and loaded into the processor 501, 601. The processor 501, 601 may include internal memory sufficient to store the application software instructions.

The foregoing method descriptions and the process flow diagrams are provided merely as illustrative examples and are not intended to require or imply that the steps of the various aspects must be performed in the order presented. As will be appreciated by one of skill in the art the order of steps in the foregoing aspects may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

As used in this application, the terms “component,” “module,” “system,” “engine,” “generator,” “manager” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic circuit, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some steps or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method of maintaining presence information of a target computing device in a server, comprising:
transmitting a pre-connect probe to the target computing device;
receiving a stream quality metric of communication links to the target computing device based on the pre-connect probe;
determining whether the stream quality metric of communication links to the target computing device exceeds a threshold;
modifying presence information regarding the target computing device to available in response to determining that the stream quality metric of communication links to the target computing device exceeds the threshold; and
modifying presence information regarding the target computing device to unavailable in response to determining that the target computing device to available in response to determining that the stream quality metric of communication links to the target computing device does not exceed the threshold.

2. The method of claim 1, further comprising:
receiving a request for presence information regarding the target computing device from a requesting computing device, wherein transmitting the pre-connect probe to the target computing device is performed in response to receiving the request for the presence information; and
sending modified presence information of the target computing device to the requesting computing device.

3. The method of claim 1, further comprising:
receiving a request for presence information regarding the target computing device from a requesting computing device, wherein transmitting the pre-connect probe to the target computing device is performed in response to receiving the request for the presence information;
transmitting a pre-connect probe to the requesting computing device;
determining an end-to-end stream quality metric between the requesting computing device and the target computing device based on stream quality metrics received from both pre-connect probes;
determining whether the end-to-end stream quality metric of communication links between the requesting computing device and the target computing device exceeds the threshold;
modifying presence information regarding the target computing device to available in response to determining that the end-to-end stream quality metric of communication links between the requesting computing device and the target computing device exceeds the threshold;
modifying the presence information of the target computing device to unavailable in response to determining that the end-to-end stream quality metric of communication links between the requesting computing device and the target computing device does not exceed the threshold; and
sending modified presence information of the target computing device to the requesting computing device.

4. The method of claim 1, wherein the threshold is a value of the stream quality metric that indicates a communication link to the target computing device is acceptable for video communications.

5. The method of claim 1, wherein the threshold is a value of the stream quality metric that indicates a communication link to the target computing device is acceptable for voice communications.

6. The method of claim 1, wherein the threshold is a value of the stream quality metric that indicates a communication link to the target computing device is acceptable for text communications.

7. The method of claim 1, wherein:
determining whether the stream quality metric of communication links to the target computing device exceeds a threshold comprises determining whether the stream quality metric of communication links to the target computing device exceeds each of a plurality of thresholds corresponding to one of a plurality of communication types;
modifying presence information regarding the target computing device to available in response to determining that the stream quality metric of communication links to the target computing device exceeds the threshold comprises modifying presence information regarding the target computing device to available for any of the plurality of communication types for which the stream quality metric exceeds the corresponding threshold; and
modifying presence information regarding the target computing device to unavailable in response to determining that the target computing device to available in response to determining that the stream quality metric of communication links to the target computing device does not exceed the threshold comprises modifying presence information regarding the target computing device to unavailable for any of the plurality of communication types for which the stream quality metric does not exceed the corresponding threshold.

8. The method of claim 1, wherein:
transmitting a pre-connect probe to the target computing device comprises determining whether the stream quality metric of at least a portion of the communication links to the target computing device are available from one or more storage elements before sending the pre-connect probe; and
receiving a stream quality metric of communication links to the target computing device based on the pre-connect probe comprises receiving the stream quality metric of at least a portion of the communication links to the target computing device before sending the pre-connect probe when the stream quality metric is determined to be available from the one or more storage elements.

9. A server, comprising:
a network connection; and
a server processor coupled to the network connection and configured with server-executable instructions to perform operations comprising:
transmitting a pre-connect probe to a target computing device;
receiving a stream quality metric of communication links to the target computing device based on the pre-connect probe;
determining whether the stream quality metric of communication links to the target computing device exceeds a threshold;
modifying presence information regarding the target computing device to available in response to determining that the stream quality metric of communication links to the target computing device exceeds the threshold; and
modifying presence information regarding the target computing device to unavailable in response to determining that the target computing device to available in response to determining that the stream quality metric of communication links to the target computing device does not exceed the threshold.

10. The server of claim 9, wherein the server processor is configured with server-executable instructions to perform operations further comprising:
receiving a request for presence information regarding the target computing device from a requesting computing device, wherein transmitting the pre-connect probe to the target computing device is performed in response to receiving the request for the presence information; and
sending modified presence information of the target computing device to the requesting computing device.

11. The server of claim 9, wherein the server processor is configured with server-executable instructions to perform operations further comprising:
receiving a request for presence information regarding the target computing device from a requesting computing device, wherein transmitting the pre-connect probe to the target computing device is performed in response to receiving the request for the presence information;
transmitting a pre-connect probe to the requesting computing device;
determining an end-to-end stream quality metric between the requesting computing device and the target computing device based on stream quality metrics received from both pre-connect probes;
determining whether the end-to-end stream quality metric of communication links between the requesting computing device and the target computing device exceeds the threshold;
modifying presence information regarding the target computing device to available in response to determining that the end-to-end stream quality metric of communication links between the requesting computing device and the target computing device exceeds the threshold;
modifying the presence information of the target computing device to unavailable in response to determining that the end-to-end stream quality metric of communication links between the requesting computing device and the target computing device does not exceed the threshold; and
sending modified presence information of the target computing device to the requesting computing device.

12. The server of claim 9, wherein the server processor is configured with server-executable instructions to perform operations such that the threshold is a value of the stream quality metric that indicates a communication link to the target computing device is acceptable for video communications.

13. The server of claim 9, wherein the server processor is configured with server-executable instructions to perform operations such that the threshold is a value of the stream quality metric that indicates a communication link to the target computing device is acceptable for voice communications.

14. The server of claim 9, wherein the server processor is configured with server-executable instructions to perform operations such that the threshold is a value of the stream quality metric that indicates a communication link to the target computing device is acceptable for text communications.

15. The server of claim 9, wherein the server processor is configured with server-executable instructions to perform operations such that:
determining whether the stream quality metric of communication links to the target computing device exceeds a threshold comprises determining whether the stream quality metric of communication links to the target computing device exceeds each of a plurality of thresholds corresponding to one of a plurality of communication types;
modifying presence information regarding the target computing device to available in response to determining that the stream quality metric of communication links to the target computing device exceeds the threshold comprises modifying presence information regarding the target computing device to available for any of the plurality of communication types for which the stream quality metric exceeds the corresponding threshold; and
modifying presence information regarding the target computing device to unavailable in response to determining that the target computing device to available in response to determining that the stream quality metric of communication links to the target computing device does not exceed the threshold comprises modifying presence information regarding the target computing device to unavailable for any of the plurality of communication types for which the stream quality metric does not exceed the corresponding threshold.

16. A communication system, comprising:
a server comprising a network connection and a server processor coupled to the network connection;
a first computing device comprising first communication circuitry and a first processor coupled to the first communication circuitry; and
a second computing device comprising second communication circuitry and a second processor coupled to the second communication circuitry;
wherein the server processor is configured with server-executable instructions to perform operations comprising:
transmitting a pre-connect probe to the second computing device;
receiving a stream quality metric of communication links to the second computing device based on the pre-connect probe;
determining whether the stream quality metric of communication links to the second computing device exceeds a threshold;
modifying presence information regarding the second computing device to available in response to determining that the stream quality metric of communication links to the second computing device exceeds the threshold; and
modifying presence information regarding the second computing device to unavailable in response to determining that the second computing device to available in response to determining that the stream quality metric of communication links to the second computing device does not exceed the threshold.

17. The communication system of claim 16, wherein:
the first processor is configured with processor-executable instructions to send a request to the server requesting presence information regarding the second computing device; and
the server processor is configured with server-executable instructions to perform operations further comprising:
receiving the request for presence information regarding the second computing device from the first computing device, wherein transmitting the pre-connect probe to the second computing device is performed in response to receiving the request for the presence information; and
sending modified presence information of the second computing device to the first computing device.

18. The communication system of claim 16, wherein:
the first processor is configured with processor-executable instructions to send a request to the server requesting presence information regarding the second computing device; and
the server processor is configured with server-executable instructions to perform operations further comprising:
receiving the request for presence information regarding the second computing device from the first computing device, wherein transmitting the pre-connect probe to the second computing device is performed in response to receiving the request for the presence information;
transmitting a pre-connect probe to the first computing device;
determining an end-to-end stream quality metric between the first computing device and the second computing device based on stream quality metrics received from both pre-connect probes;
determining whether the end-to-end stream quality metric of communication links between the first computing device and the second computing device exceeds the threshold;
modifying presence information regarding the second computing device to available in response to determining that the end-to-end stream quality metric of communication links between the first computing device and the second computing device exceeds the threshold;
modifying the presence information of the second computing device to unavailable in response to determining that the end-to-end stream quality metric of communication links between the first computing device and the second computing device does not exceed the threshold; and
sending modified presence information of the second computing device to the first computing device.

19. The communication system of claim 16, wherein the server processor is configured with server-executable instructions to perform operations such that:
determining whether the stream quality metric of communication links to the second computing device exceeds a threshold comprises determining whether the stream quality metric of communication links to the second computing device exceeds each of a plurality of thresholds corresponding to one of a plurality of communication types;
modifying presence information regarding the second computing device to available in response to determining that the stream quality metric of communication links to the second computing device exceeds the threshold comprises modifying presence information regarding the second computing device to available for any of the plurality of communication types for which the stream quality metric exceeds the corresponding threshold; and
modifying presence information regarding the second computing device to unavailable in response to determining that the second computing device to available in response to determining that the stream quality metric of communication links to the second computing device does not exceed the threshold comprises modifying presence information regarding the second computing device to unavailable for any of the plurality of communication types for which the stream quality metric does not exceed the corresponding threshold.

20. The communication system of claim 16, wherein the second processor is configured with processor-executable instructions to perform operations comprising replying to the pre-connect probe from the server by transmitting a message including at least one stream quality metric of a communication link communicating the pre-connect probe to the second computing device.
